(19) United States
(12) Patent Application Publication
(10) Pub. No.: US 2016/0325127 A1
(43) Pub. Date: Nov. 10, 2016

(54) Laser System Module-Equipped Firefighting Aircraft

(71) Applicant: Kenneth William Billman, Mountain View, CA (US)

(72) Inventor: Kenneth William Billman, Mountain View, CA (US)

(21) Appl. No.: 14/934,691

(22) Filed: Nov. 6, 2015

Related U.S. Application Data
(60) Provisional application No. 62/077,057, filed on Nov. 7, 2014.

(51) Int. Cl. A62C 3/02; B64C 39/02; B64D 47/00; B64D 47/08; B64D 1/16

(52) U.S. Cl. CPC A62C 3/0285; B64D 47/08; B64D 1/16; B64D 47/00; B64C 39/024

(57) ABSTRACT

In the first embodiment, an aircraft (30) is fitted with a laser system module (34) whose focused laser beam (38) may be directed by its crew controlled beam director (42) to treetop or ground foliage (40L) beyond an advancing wildfire in order to set backfires (40R) which cause said wildfire to subside when reaching the depleted fuel. Unlike conventional backfire dispensing ignited liquid from a low-flying helicopter or by hand, said aircraft can quickly arrive on scene and crew (32), using its infrared imaging system to see through darkness and smoke, can precisely and rapidly set the backfire line using laser beam ignition from a safe distance without the usual small distance risk to pilot or ground firefighter. Said module subsystem design is outlined and is made interchangeable with conventional firefighting and water/chemical spaying modules, insuring said aircraft receives usage beyond the fire season. Other embodiments are discussed.

### CROSS-REFERENCE TO RELATED APPLICATIONS

This application claims the benefit of provisional patent application Ser. No. 62/077,057, filed Nov. 7, 2014 by the present inventor.

### BACKGROUND-PRIOR ART

The following is a tabulation of some prior art that presently appears relevant:

U.S. Patents

| Pat. No. | Kind Code | Issue Date | Patentee |
|---|---|---|---|
| U.S. Pat. No. 3,897,829 | A | 1975 Aug. 5 | Ward Eason |
| U.S. Pat. No. 4,090,567 | A | 1978 May 23 | Francis |
| | | | Tomlinson |
| U.S. Pat. No. 3,897,829 | A | 1996 Aug. 27 | Edward Herlik |

U.S. Patent Application Publications

| Publication Nr. | Kind Code | Publ. Date | Applicant |
|---|---|---|---|
| 2005014394 | A1 | 2005 Feb. 17 | Roger Payassis |
| 2013/0199806 | A1 | 2013-08-2013 | Simplex Manufacturing Co. |

Foreign Patent Documents

| | | | | App or |
|---|---|---|---|---|
| Foreign Doc. Nr. | Country Code | Kind Code | Pub. Dt | Patentee |
| N/A | IS | N/A | N/A | Daniel Leigh, |
| | | | | Zvika Avni |

### NONPATENT LITERATURE DOCUMENTS AND WEB LINKS*

Ref. 1 “Controlled Burn” Backburn or Controlled Burn Overview
   See Link: http://en.wikipedia.org/wiki/Controlled_bum
Ref. 2 “Helitack” Article refers to “helicopter-delivered fire resources”
   See Link: http://en.wikipedia.org/wiki/Helitack
Ref. 3 CAL Fire aircraft fleet
   See Link: www.fire.ca.gov/
Ref. 4 Sikorsky S-64 Skycrane Helicopter
   See Link: http://en.wikipedia.org/wiki/Sikorsky_S-64_Skycrane
Ref. 5 Kaman K-MAX Helicopter
   See Link: http://en.wikipedia.org/wiki/Kaman_K-MAX
Ref. 6 LM UAVs Vector Hawk and Fire Scout
   See Link: http://www.lockheedmartin.com/us/news/press-releases/2014/may/140513-mst-lm-introduces-latest-addition-to-suas-family.html
   See Link: http://www.ainonline.com/aviation-news/dubai-air-show/2011-11-14/fire-scout-proves-its-value-middle-east-warzones
Ref. 7 Airborne Laser Laboratory (ALL)
   See Link: http://www.fas.org/spp/starwars/proeram/all.htm
Ref. 8 Airborne Laser (ABL)—YAL-1
   See Link: http://en.wikipedia.org/wiki/Boeing_YAL-1
Ref. 9 Advanced Tactical Laser (ATL)
   See Link: http://en.wikipedia.org/wiki/Advanced_Tactical_Laser
Ref. 10 21'st Century Revolution of Forest Fire Suppression, by David Leigh and Zvika Avni
   See Link: http://www.fightingtreetopfire.com/#!about/cig9
Ref. 11 Simplex Aerospace—Firefighting aircraft
   See Link: https://www.google.com/webhp?sourceid=chrome-instant&ion=1&espv=2&ie=UTF-8#q=Simplex %20Aerospace
Ref. 12 MZA Associates Corp.—Othela Beam Director
   See Link: https://www.mza.com/about_us.php?page=aboutNews&article=10
Ref. 13 LM Aculight 60 kW RELI Program See Link: http://www.militaryaerospace.com/articles/2013/09/aculight-laser-weapon.html
Ref. 14 “Introduction to Laser Weapon Systems”, by G. Perram, S. Cusumano, R. Hengehold, and S. Fiorino, Directed Energy Professional Society, Albuquerque, N. Mex., 2010
Ref. 15 “Beam Control for Laser Systems”, by Paul Merritt, Directed Energy Professional Society, Albuquerque, N. Mex., 2012.
Ref 16 Unmanned aerial vehicles
   See Link: http://en.wikipedia.org/wiki/Unmanned_aerial_vehicle
      *Note: To see document at web link, press Ctrl+Link when finger is on link address

This invention relates generally to manned and unmanned fixed wing aircraft and rotorcraft systems that can perform multiple tasks using interchangeable modular subsystem equipment. A few of these tasks are (a) wildfire suppression, either by laser backfire setting or the more conventional water-chemical drop or spray (b) fire suppression of high rise buildings or other structures by chemical spraying, (c) agriculture use, including crop fertilizing, disinfecting, or watering, and (d) remote cleaning of power lines and associated equipment, of buildings, of windmills, or other items. This multipurpose capability allows year-long aircraft utility rather than just single use fire suppression.

Certain multiple use manned aircraft and helicopter firefighting capability has been developed in prior art as will be outlined here. (See Refs. 1-3, 11) We also include here the recently developed manned and unmanned autonomous aircraft and helicopters (Refs. 4-6). Additionally, we also add herein the important capability and methodology to use modular insertable laser systems for enabling aircraft for rapid, precise, operator safe setting of backfires for the early containment of a developing wildfire as well as for other opportunistic laser system uses.

Fighting fires using backfire technology has been developed over many years (Refs. 1-2). It was first based upon short-range manual fire-setting means such as use of torches, hot or explosive projectiles, and the dripping of burning chemicals, such as a mix of kerosene and gasoline, from hand-held canisters. Of course these manual methods expose the fire fighters to possible flare-ups of the main conflagration and falling trees. It also is limited to accessible, man-negotiable forest areas. Additionally, this process is very slow both in setup, requiring flying in to drop in operators to the desired backfire region, and then in the “hot-shots” manual fire-setting execution.

To improve on this manual backfire approach, helicopter approaches were developed (Refs. 2-4). In these, the helicopter holds a torch or a dispenser of a flaming chemical on a cable which is maintained slightly above the ground. While this removes the man-on-the-ground safety issue, now the crew is at risk since the helicopter must fly relatively close to the ground in order to minimize the sway of the cable to allow some precision in the setting of the backfire line. This issue is exasperated because of the upwelling winds that are produced by a large fire and its smoke that may obscure vision. In addition, the helicopter is restricted to certain airspace, away from power lines, hills, and other aircraft, and therefore its backfire cannot always be placed in the desired location. And finally, the rate of setting this backfire by the torch or dribbled incandescent chemical means is very slow, thus allowing time for the fire to spread before efficacious backfire suppression.

Herein we will show that a craft equipped with a properly configured laser system can obviate many of these shortcomings. We begin by showing three military airborne laser systems (Refs. 7-9), Airborne Laser Laboratory, Airborne Laser Testbed and Advanced Tactical Laser that have already shown how such an airborne laser system can propagate its beam over large distances to precisely position the beam to deposit its energy on a succession of target aimpoints. But those military systems are not suitable for the needed firefighting service since they use large, heavy, low efficiency chemical lasers which are very difficult to service in the field and also which provide much higher laser beam power than needed.

In the applications discussed herein the range and power requirements are much lower than these prior demonstrated laser systems. This allows the use of much smaller and lower weight, laser systems rather than heavy chemical lasers. Although the lower power lasers provide shorter range backfire starting capability, even with an easily achievable range capability of up to a kilometer the craft will be out of harm's way. It also will have an excellent field of view to see the conflagration and chose the optimal backfire path to quickly set. We estimate that the times to set the foliage afire will be at least ten times faster than by the state of art burning drip means. The will allow both backfire of treetops as well as ground fire to be easily set. David Leigh and Zrika Arni (Ref. 10) have claimed that treetop backfires may be a better method than ground backfires. Herein we provide the laser system design approaches that would allow fulfillment of their speculation. Such capability is only assumed in their referenced work without consideration of the many requirements and design issues required for operational firefighting capable laser airborne systems as we consider herein.

In particular, the state-of-art laser system designs we will consider will be based upon the use of the electrically-driven, lightweight RELI (Robust Electric Laser Initiative)-class lasers (Ref. 13). Other electric-driven laser types, and perhaps others, would also suffice if they provide the desirable characteristics of the RELI class lasers. The lighter RELI weight, higher efficiency, better beam quality, and robustness for reliable operation in a severe environment, like that encountered by a fire-fighting helicopter, offer a more tolerant capability for the variety of helicopter lift capabilities that might be used for the multipurpose applications we desire.

### SUMMARY

In accordance with one embodiment, an air vehicle (manned or unmanned aircraft, helicopter, or lighter-than-air ship) equipped with a moderately high power laser system module, said module configured to allow quick insertion or replacement into the craft, that has a means of controlled beam pointing and tracking, is equipped with an infrared or other imaging system to allow observation in darkness or even through smoke of the nearby fire or of the laser beam target interaction, will provide a safe range and rapidly implementable means to set backfires to more quickly contain conflagrations. In addition, there are other uses of such laser beams beyond firefighting. These include setting controlled burns and cleaning of dust from high tension equipment. And, because of the designed-in laser module insertion/removal capability, the air vehicle will additionally be capable of other than backfire setting. Replacement of the laser module with a state-of-art water or chemical holding tank would allow the aircraft to perform that conventional mode of firefighting. Of course it would also enable agriculture fertilizing or chemical pest control spraying.

Their modular exchange capability would allow these aircraft to carry out these and many other tasks throughout the year even outside the usually short 3-4 month fire season. This would enhance the modules' financial benefit.

Advantage The details of one or more embodiments of the invention are set forth in certain of the accompanying drawings and their description below. Other features, objects, and advantages of the invention will be apparent from the description and drawings, and from the claims.

### DRAWINGS

### Figures—Pictures

In these, closely related figures have the same number but different alphabetic suffixes.

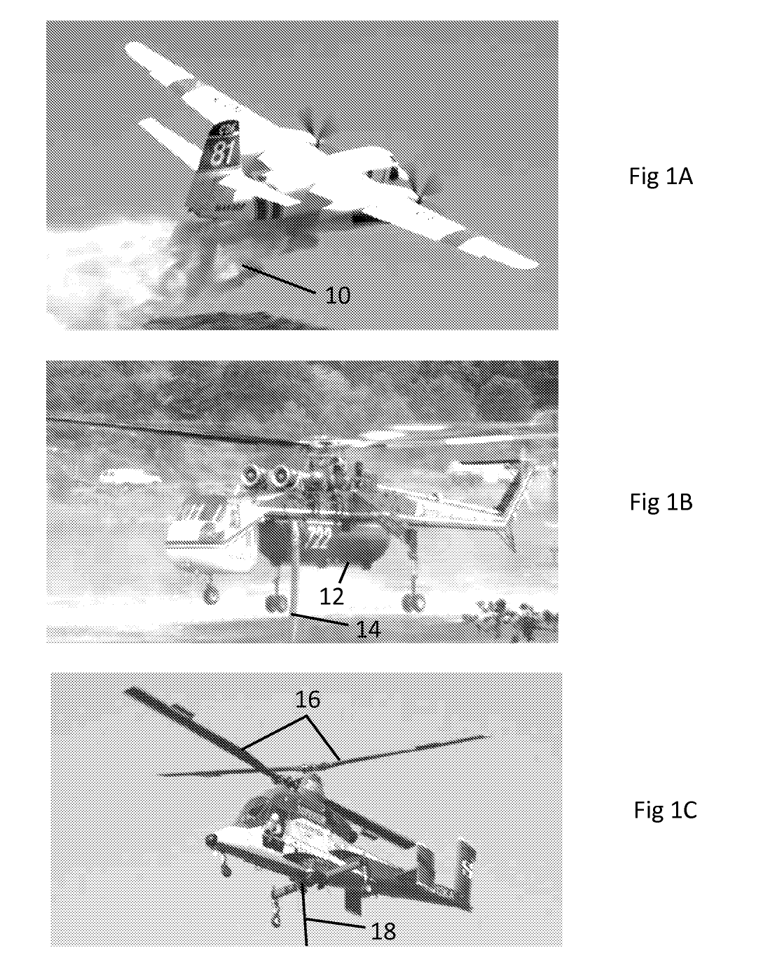

FIGS. 1A to 1C show examples of conventional, i.e. not presently laser module system equipped, firefighting craft in state of California's “CAL Fire” 50-craft inventory (Ref. 3).

FIG. 1A shows an example state-of-art fixed wing firefighting aircraft, a Grumman S-2T tanker, modified to enable airborne release of fire retardant 10.

FIG. 1B shows an example state-of-art helicopter firefighting craft, a Sikorsky S-64 “Skycrane”, modified to carry a 2,650 gallon retardant tank 12. Its tank refill hose is 14.

FIG. 1C shows a multi-purpose craft, a Kaman “K-Max” single pilot, dual prop 16 heavy lift helicopter used for a variety of missions ranging from logging and thinning to backfire-fighting. Payloads are supported by the cable 18.

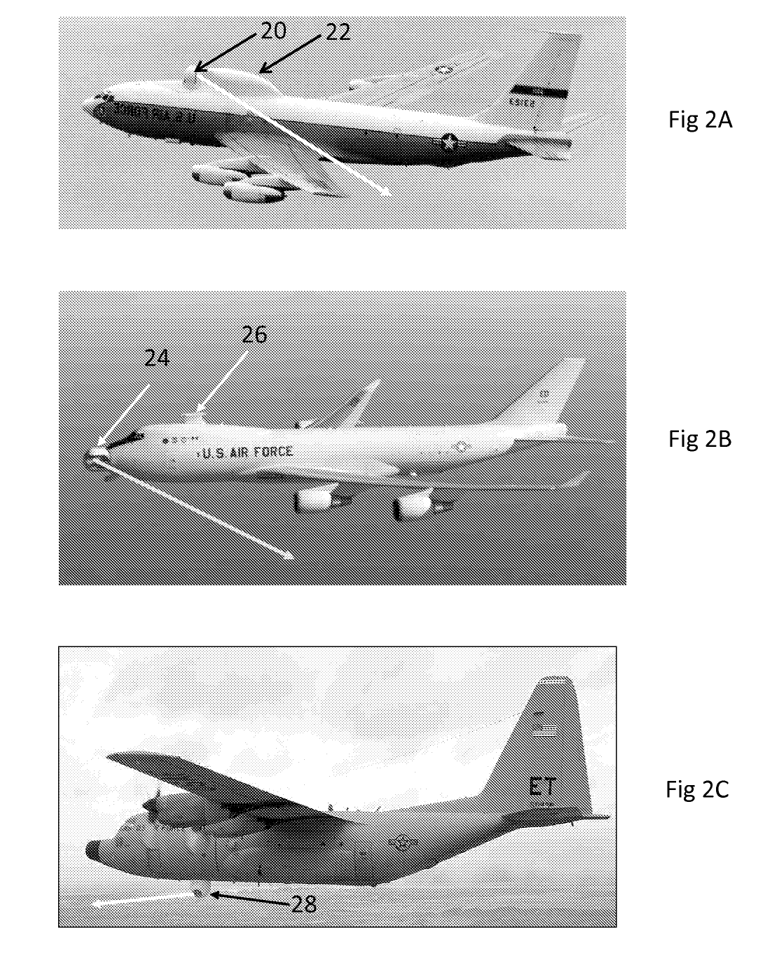

FIGS. 2A to 2C show the U.S. military aircraft equipped with laser weapon systems which have demonstrated laser system military capability but do not meet the operational specifications for firefighting.

FIG. 2A shows the Airborne Laser Laboratory (ALL) that had a powerful 500 kW-class gas-dynamic laser system within in its modified version of a KC-135 aircraft. It directed its beam to targets using its beam director 20 mounted atop its fuselage. An adjacent aerodynamic foil 22 minimized its wind buffeting. During its demonstration period, prior to decommission in 1989, it destroyed five AIM-9 Sidewinder air-to-air missiles, a Navy BQM-34A target drone and other targets.

FIG. 2B shows the Airborne Laser (ABL) Testbed that had a MW-class chemical laser system mounted in its modified Boeing 747-400F aircraft. It was equipped with innovative beam control technology, including 24, a nose-mounted telescope and 26, a laser ranger mounted atop its fuselage. In late 2009 the ABL fulfilled its demonstration goal to be the first laser equipped aircraft to destroy a distant, fast-moving, theater ballistic missile in its boost phase. It was decommissioned in 2012.

FIG. 2C shows the Advanced Tactical Laser (ATL) which used a 100 kW-class chemical laser system installed within a modified C-130H aircraft to demonstrate its ability to engage tactical targets from a moving platform at maximum range of about 10 kilometers. As seen it used a third method of mounting its beam director 28, on its belly. Before its decommissioning ATL demonstrated the ability to hit and combust ground based targets.

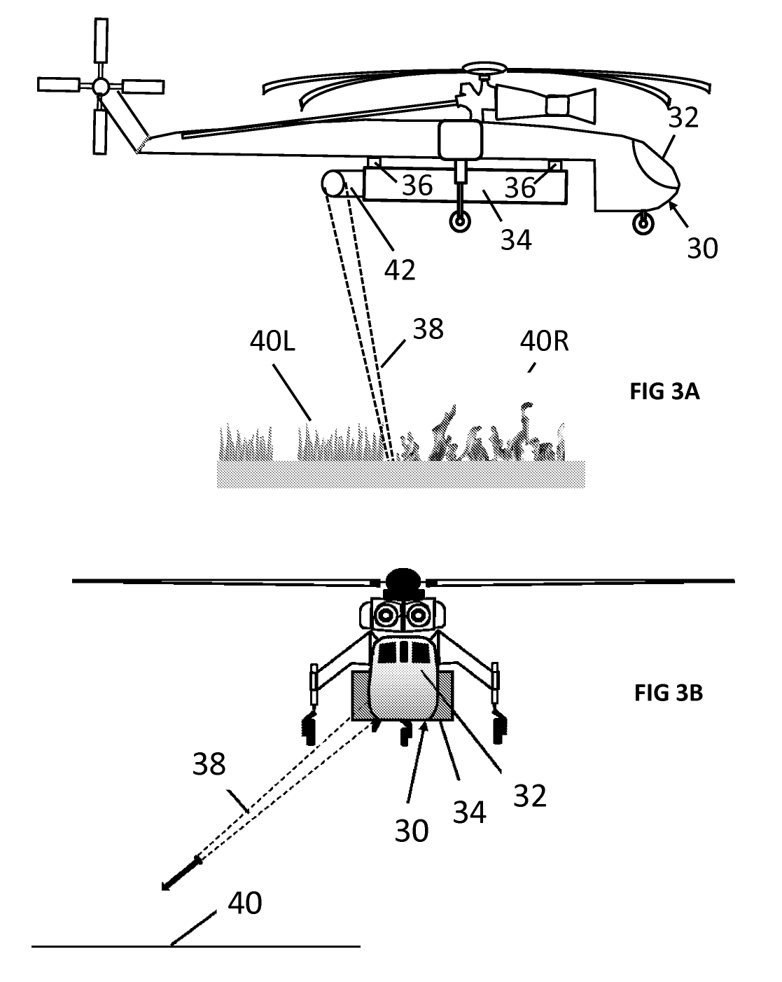

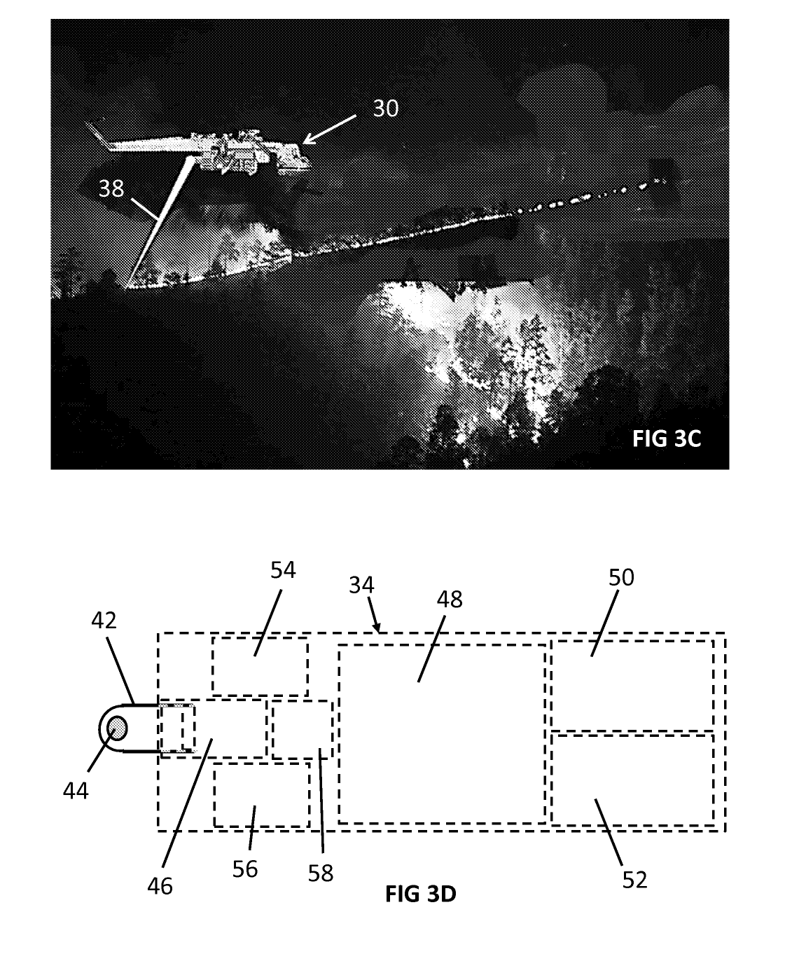

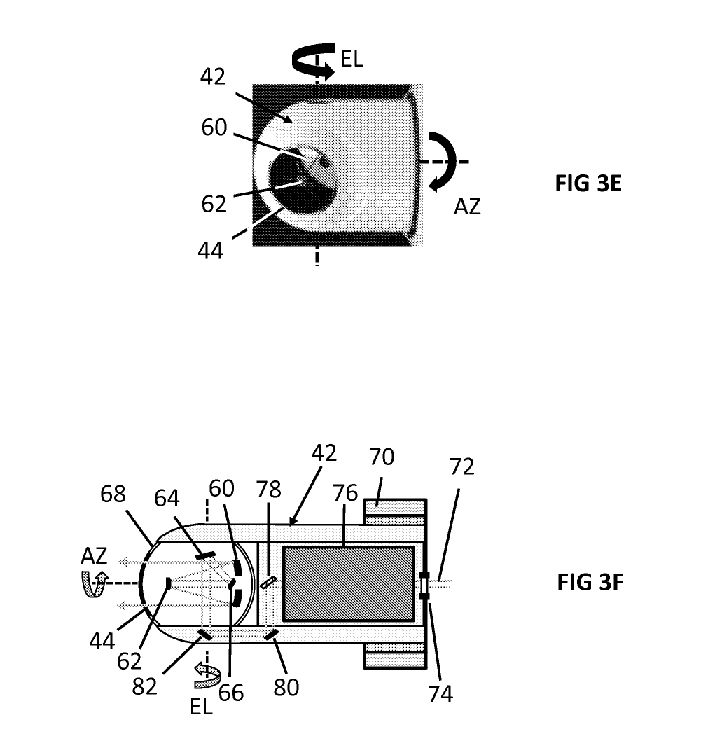

FIGS. 3A to 3F show our invention's first embodiment, a laser system module-equipped firefighting helicopter and its subsystems

FIG. 3A shows a typical firefighting helicopter, a Sikorsky S-64 in side view, fitted with a laser system module, replacing its water tank that was seen in FIG. 1B.

FIG. 3B shows a frontal view of the laser system module-equipped helicopter.

FIG. 3C is mockup of a laser system module-equipped Sikorsky S-64 30 laying down a backfire line with its focused, beam directed laser beam 38

FIG. 3D shows a bottom view of the helicopter laser system module 34 showing a typical interior layout of the module's subsystem components. (Note that this drawing is not to scale.)

FIG. 3E shows a picture of the subassembly 42 which holds the beam director telescope subassembly and the beam control system subassembly.

FIG. 3F shows the components of subassembly 42 and traces the laser beam 72 from entrance to the unit, through the beam control subassembly 76, then through the telescope subassembly 68, and out the exit window 44.

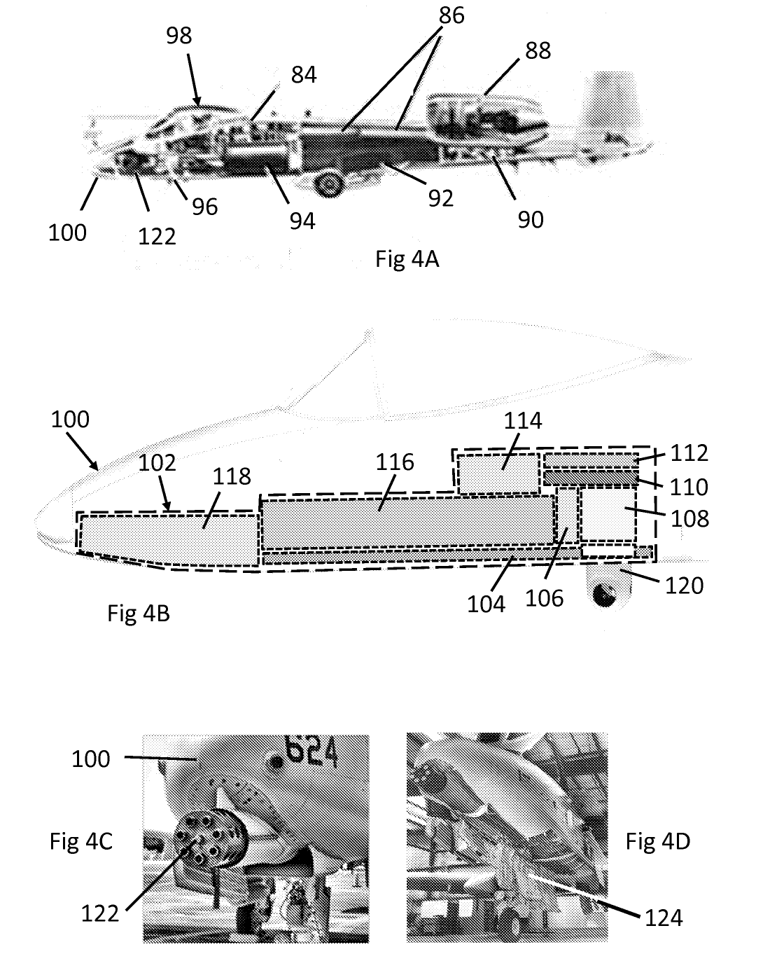

FIGS. 4A to 4D show another invention embodiment, a military fixed wing aircraft 98 and its modified interior replacing its armament with a laser system module to equip it for firefighting and other multitask uses.

FIG. 4A shows a center plane sectional view of the pre-modified craft 98, a Northrop Grumman A-10 Thunderbolt-II fixed wing aircraft as outfitted for Military service.

FIG. 4B shows an interior layout of the subsystems of the laser system module in the A-10 as modified for laser module-assisted firefighting. (Note that the relative subassembly dimensions are not to scale although the overall laser system envelope is to scale relative to the aircraft's scale.)

FIGS. 4C-4D show two more photos of the military-equipped A-10. FIG. 4C shows the 30 mm GAU-8/A seven-barrel Gatling gun 122 and FIG. 4D shows the access doors 124 for gun servicing. These doors will allow access for ease of replacement of the GAU-8/A gun with the laser system module.

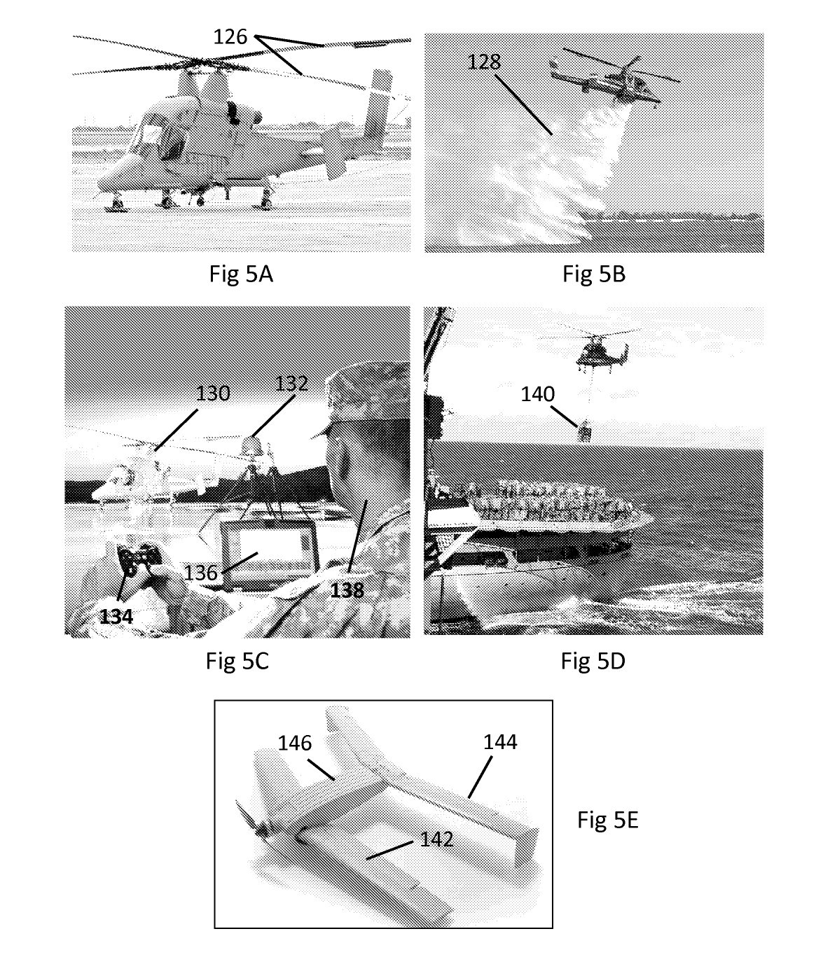

FIGS. 5A to 5E show pictures relevant to another embodiment, use of Unmanned Aerial Vehicles (UAVs) for aerial laser firefighting and other multi-tasking.

FIG. 5A shows the Lockheed Martin pilot-less K-MAX helicopter, representative of a class of such craft that could carry a laser system module to allow very rapid deployment and close-in firefighting while avoiding human risk. Note the counter-rotating helicopter blades 126 for stability and lift.

FIG. 5B shows this helicopter type, in this case a Kaman-owned K-MAX modified to fire fight using a water/retardant storage tank. A typical tank effluent plume 128 is shown.

FIG. 5C shows the Lockheed Martin-Kaman K-MAX 130 undergoing a remote control demonstration for its U.S Marine program.

FIG. 5D shows the K-MAX UAV lowering a cable-suspended payload 140 precisely onto the deck of a ship. The stability of this dual rotor helicopter bodes well for supporting a spin-stabilized laser system module in this fashion.

FIG. 5E shows the Lockheed Martin Vector Hawk autonomous miniature aircraft 146 that could carry a small designator laser and/or an infrared imager for fire surveillance.

### DRAWINGS, FIGURES, PICTURES

### Reference Numerals

| | | | | |
|---|---|---|---|---|
| FIGS. 1A to 1C | 10 | Non-uniform retardant plume | 12 | Replaceable retardant tank |
| | 14 | In-flight tank refill hose | 16 | Counter-rotating blades |
| | 18 | Load suspending cable | | |
| FIGS. 2A to 2C | 20 | ALL laser beam director | 22 | Aerodynamic fairing |
| | 24 | ABL laser beam director | 26 | Active ranging system |
| | 28 | ATL laser beam director | | |
| FIGS. 3A to 3D | 30 | Typical outfitted helicopter | 32 | Flight and laser controls |
| | 34 | Laser system module (LSM) | 36 | LSM attach points (2 of 4) |
| | 38 | Typical directed laser beam | 40 | Target area |
| | 42 | Telescope-Beam Ctrl Assy. TBCA | 44 | Laser beam output window |
| | 46 | Storage volume for TBCA | 48 | High Energy Laser (HEL) |
| | 50 | Power control subassembly | 52 | Waste heat control sa. |
| | 54 | Real-Time Fire Control sa. | 56 | Tracking & Imaging sa. |
| | 58 | Beam Transfer subassembly | 60 | Primary Mirror |
| | 62 | Secondary Mirror | 64 | YAW Mirror |
| | 66 | Half Angle Mirror | 68 | Telescope Housing |
| | 70 | Stator/Rotor Bearing | 72 | Beam from Beam Xfer Assy. |
| | 74 | Beam input window | 76 | Beam Control Subsystem |
| | 78 | Coude' Mirror #1 | 80 | Coude' Mirror #2 |
| | 82 | Coude' Mirror #3 | | |
| FIGS. 4A to 4D | 84 | Electronics & Avionics | 86 | Main fuel tanks |
| | 88 | GE TF-34 Engine | 90 | Auxiliary Power Unit |
| | 92 | Wing Fuel Tank | 94 | Armor Drum |
| | 96 | Cockpit armor | 98 | Military A-10 Thunderbolt-II |
| | 100 | A-10 aircraft nose | 102 | Laser module chamber |
| | 104 | Vibration Isolation Bench | 106 | Beam Transfer assy. |
| | 108 | Storage volume for TBCA | 110 | Active Tracking Module |
| | 112 | Tracking & Imaging Module | 114 | Real Time Fire Control Mod. |
| | 116 | High Energy Laser (HEL) | 118 | Power & Thermal Module |
| | 120 | Telescope-Beam Ctrl Assy. | 122 | A-10 GAU-8/A Gatling Gun |
| | 124 | Access doors to Interior | | |
| FIGS. 5A to 5E | 126 | Counter-rotating blades | 128 | Z-MAX retardant plume |
| | 130 | LM Marine Z-MAX aircraft | 132 | Antennas |
| | 134 | Modern “Joy Stick” in hand | 136 | Computer interface screen |
| | 138 | Remote piloting the Z-MAX | 140 | Z-MAX cable loading to deck |
| | 142 | UAV’s left foldable wing | 144 | UAV's left foldable tail fin |
| | 146 | Main body of LM Vector Hawk | | |

### DETAILED DESCRIPTION

### FIGS. 3A to 3E

### First Embodiment

One embodiment of the invention is illustrated in FIG. 3A (right side view) and FIG. 3B (front view) showing a typical laser system module outfitted aircraft, in this case a Sikorsky S-64 Skycrane Heavy Lift Helicopter 30. FIG. 3C shows a bottom interior view of the laser system (LS) module illustrating its major subsystem components. FIG. 3D shows a photo, and FIG. 3E the components, of a module subsystem, a typical telescope beam director assembly 42. This helicopter is now manufactured by Erikson Air-Crane, Inc., Portland, Oreg. Simplex Aerospace, Portland, Oreg. outfits the craft for its conventional Fire Attack task, to drop or spray water or other chemicals from a holding tank (as was seen in the photo 1B). To allow for interchange of this tank for other modules, allowing dual use capability of the aircraft, the tank 34 is quick-clamped by hydraulic fittings 36 in FIGS. 3A and 3B. Our embodiment uses this same holding method developed by Simplex Aerospace, thus allowing the dual use scheme they perfected for their chemical tank to be used for our laser system module chamber. Note that just as in its normal water/chemical drop firefighting mode this laser enhanced system will be controlled from those in the cockpit 32, usually a pilot that controls the craft and a co-pilot that controls the firefighting effort. The operational aspects of the backfire setting aircraft mode, shown here with an intense focused laser beam 38 impacting targets 40 such as treetops or ground foliage (40L) and resulting fire (40R), will be discussed later when we complete identification of the major laser system equipment elements. FIG. 3C shows a mockup of such a backfire being set along a timberline by our first embodiment laser module equipped Sikorsky helicopter.

FIG. 3B shows a frontal view of this Sikorsky CH-54/S-64. The so-called “Air Crane” has extremely large payload weight (about 10,000 kgs or 22,050 lbs) and volume carrying capability. The latter is very large since it can even transport things like houses held from the helicopter's cables. In the embodiment figures shown we have assumed the laser module box 34 to be about 5 m (16.4 ft) in width, 2 m (6.6 ft) in height, as seen in FIG. 3B, and 6.4 m length as seen in 3A. As reference, the aircraft is 21.4 m in length and 5.67 m in height. Its cruising speed is 169 km/hr. Note that other helicopters with less or more capability may also serve to carry other laser system modules for the firefighting service we claim in this embodiment. With more payload/volume capability a more powerful laser system could be used and this would increase the rate of setting the backfire. Alternatively, some of that higher weight capability could be used to increase aircraft fuel capability and hence the range and time in the air before needing to refuel. Such trades between margins for the carrier and the laser system load are common for those familiar in the laser weapon systems trade (Ref. 14). Below, as the laser subsystem assemblies are discussed, similar trades are encountered. Ref. (15) discusses such state-of-art issues in his book Beam Control for Laser Systems.

In the embodiment discussed here, 34 is the typical laser system (LS) module which will be more fully discussed below in FIG. 3D, FIG. 3E and FIG. 3F. Note the rear protrusion 42 from the module, in FIGS. 3A and 3D) and the photo in FIG. 3E. This is the laser beam director assembly which contains the optics that directs the laser beam to the target area where the laser-induced backfire is to be set. While there are many commercial versions of such a subassembly, in this embodiment we use as an example the “Othela” module (Ref. 12) manufactured by MZA Associates, Corp., in Albuquerque, N. Mex. This particular commercial unit 42 contains many components and subassemblies as seen in FIGS. 3E and 3F. In FIG. 3F, following the laser beam 72 that unit 42 receives as input through its components is a convenient way to identify those components. After passing through the input window 74, the beam enters the set of optical elements in the Beam Control Assembly 76. As its BCA name implies, these optics precondition the optical beam for its path ahead so that is arrives with desired good focus and with little jitter and beam wander away from its desired point of impact on the treetop or foliage. Since this electro-optic assemblage varies with the type of usage desired and its level of detail exceeds what is desired in this document, we consider it a “undefined black box” here. We will do this for other boxes seen in FIG. 3C as well, only providing functional information but not internal detail. There are many manufacturers like MZA Associates that sell such subassemblies designed to customer specifications.

Exiting the BCA, the laser beam encounters 78, the first of three successive Coude′ mirrors 78, 80, and 82. Then it is deflected by the YAW mirror 64 to hit the Half-Angle mirror 66. This series of five mirrors accomplishes an important task, namely to keep the forward moving laser beam aligned with the turret axis, from whence it began, to now as it leaves mirror 66, even as the turret assembly 42 is rotated about its axis using the rotational bearing assembly 70. This turret rotation is the azimuthal angle, indicated as AZ in FIGS. 3D and 3E. There is a second rotation angle EL, the elevation angle also seen in the figures. This corresponds to the rotation of 68 the spherical shell that holds the telescope's secondary mirror 62 and primary mirror 60. In the figure the EL angle is 0 degrees and the beam leaves the shell though its output window 44 moving along the turret axis. If the operator commands it to move 90 degrees, the beam would move orthogonally out of the plane of the figure. Then on command of the operator for the turret to rotate by an AZ angle change of −90 degrees, the beam would move orthogonal to the turret axis downward to the bottom of the figure. Clearly the operator has a wide range of beam direction angles that are at his control by rotating the turret about its axis combined with a rotation of the telescope's shell. However it is written into the controller's real time control software, instructions for the laser beam to cease whenever an angular choice would have the beam strike the aircraft, its landing gear, or any other than the desired treetop or foliage.

Another aspect of the telescope is its ability to expand the beam's diameter and to focus that expanded beam onto the distant target. It is an important design trade to choose as large of a diameter as is consistent with allowed telescope weight and volume in the laser system module since it's diameter size sets the laser beam's smallest focal spot size at the target. Then, as the beam reflects from 66, the half-angle mirror, it strikes the secondary mirror, 62. This convex mirror reflects the beam into an expanding beam that just fills the primary mirror 60. The primary is a concave focusing mirror. As the secondary mirror's axial distance between it and the primary mirror is changed under control of the secondary, the telescope's focal length is adjustable. This allows the real-time controller, either manually or under computer control, to focus the beam for maximum backfire setting effect on the target.

Moving now to FIG. 3C we examine the other elements of the laser system module 34. The genesis of the laser beam is the High Energy Laser (HEL) 48. Assembly 50 is the power system which, as stated earlier, provides controlled electric power for all system assemblies and also for the electric-driven laser. The Waste Heat Control and Cooling Assembly 52, maintains the desired temperatures throughout the system.

Nominal beam pointing control is provided through the unit 54, the Real-Time Fire Control Assembly. This electronic computer assembly uses pointing techniques that have matured mostly under military technology development. In the ALL and ATL laser aircraft, “joy stick” beam pointing control was developed and successfully used. In the ABL program we perfected the technique for computer controlled autonomous target acquisition and tracking. In the present embodiment, both Joy Stick and pre-planned computer autonomous track setting and GPS-assisted execution will be provided.

The Tracking & Imaging Subassembly 56 provides imaging of the terrain and foliage in which the backfire is being set. Techniques for tracking the hot spot's path are similar to those we have developed for laser weapon systems. Frequently 56 and 32 work together in this regard, for example an infrared image camera in 56 will see through the smoke and provide the Joy Stick operator located in the cockpit 32 with scene information needed to guide the laser “hot spot” backfire setting.

Completing the laser beam odyssey through the system module, the beam leaves the HEL 48 and enters the Beam Transfer Assembly 58. This unit resizes the laser beam and cores it as needed to fit the requirements of the turret assembly. 58 also removes any beam walk and beam jitter that appears in the HEL beam so that these effects are not present as the beam passes through the void region 46 and enters the turret as beam 72. The 46 is a storage space left to withdraw the turret assembly 42 when the laser is not in use in order to protect it from debris during flight. A bird strike protective cover, not shown, might also be used to close the aperture input.

### Operational Concept

The operational concept for this first embodiment is as follows. Prior to the fire season, the helicopter is assumed to be outfitted at various times with differing modules for its many agriculture, power company, logging, and other tasks as has been done in the past. But when fire season approaches the craft would normally be outfitted with its water/chemical tank for traditional firefighting. Alternatively, the new laser backfire option may be used by a quick and straightforward replacement of the tank with the laser system module. For this helicopter the rate of climb to altitude is 405 m/min, its cruise speed is 169-203 km/hr, and its range is 370 km. Hence it should arrive at the early stages of the fire in order to start setting a backfire downwind of the conflagration so as to remove possible fuel for the fire's spread. FIG. 3C was a mock-up of such a backfire activity. David Leigh and Zvika Avni (Ref. 10) have suggested that removing the tree-top combustible material is an especially effective backfire technique. They suggest a generic airborne laser to do this but no design information. In contrast, this patent provides example airborne laser systems that can serve this purpose. In addition to the treetop backfires, more conventional ground level backfires may be set by the laser beam. As stated earlier, these backfires will be much quicker accomplished with the laser than by state-of-art non-laser system means. Finally, if after all the desired backfires are set, the craft can go into a infrared search mode for other hot spots or needed additional backfires. Alternatively it may return to base. There it may, if desired change out its laser system module for the water/chemical tank and return to fight the main conflagration using this conventional means.

### FIGS. 4A to 4C

### First Alternative Embodiment

To illustrate that in addition to helicopter designs, there are also fixed wing aircraft laser system module designs, we consider those aircraft here. While those of us in the laser weapon system design field have considered pallet-loaded laser systems that could fit into large cargo aircraft like the Lockheed Martin C130J, the recent development of the previously discussed lightweight, smaller volume, higher efficiency and hence lower electric power and waste heat cooling requirements, RELI-class lasers makes the fixed wing fighter concept discussed here certainly possible. Previously, a fixed wing state-of-art water/chemical firefighter approach had been patented by Edward C. Herlik (U.S. Pat. No. 5,549,259) awarded 27 Aug. 1996. As seen therein, to illustrate this concept he used the fighter aircraft Fairchild/Northrop Grumman A-10 Thunderbolt-II shown in FIG. 4A. In its militarized configuration shown, it is an incredible craft. Its overall length is 16.16 m (53.3 ft) and height is 4.42 m (4.42 m (14.75 ft); payload capacity is 7,257 kg (11,000 lbs); maximum speed is Mach 0.56 (420 mph); and range 695 nautical miles (800 miles).

Herlik de-militarized the A-10, as we will also assume, first modifying it by removing the 30 mm GAU-8/A seven-barrel Gatling gun 122 and its armament storage drum 94, other military armor protection such as the cockpit armor 96, the two wing fuel tanks 92, and miscellaneous other military hardware not needed for firefighting. One or two new fuel cells were placed in the nose, using some space that was previously occupied by the gun. (See also FIG. 4C for pictures showing this large gun 122 and access doors 124.) We also assume such modifications in FIG. 4B, and the fuel cells to power 118, our Electric Power and Thermal Control Assembly for our laser system module. Finally, we also assume the available envelope that Herlik used for his firefighting water tanks and pumps, but in our case for the laser module subsystem assemblies as seen in FIG. 4B. That envelope is about 4.78 m (15.7 ft) in length, having a maximum height of 3.38 m (11.1 ft), and an average width (normal to the plane of the drawing) of 1.64 m (5.39 ft). The volume of this envelope is about 5.7 m³.

Note that the U.S. Defense Advanced Project Agency (DARPA) is nearing completion of its program to develop a 100 kW HELLADS laser system with a smaller total volume of 1 m×1 m×3 m=3 m³. And since our baseline RELI laser is being developed to have equivalent, or even lower volume and weight per unit output power, a 60 kW RELI system should find the available volume of 5.7 m³ more than adequate.

This laser system module seen in FIG. 4B, enclosed in the shell 102, contains the same major subsystems as were required previously in the first embodiment. 120 is the Turret containing the Telescope and Beam Control Assembly, 108 is its recess for storage, 110 is the Active Tracking Module, 106 is the Beam Transfer Assembly, 112 the Tracking and Imaging module, and 116 is the High Energy Laser which rests on its Vibration Isolation Bench, 104. Note that the craft is outfitted, as was the helicopter, with 114, a Real-Time Fire Control Assembly which includes IR imaging, allowing it to let the pilot to see through smoke and also to operate at night. Note that as with the first embodiment, the Turret 120 needs to be stowed and its recess volume 108 capped for protection whenever the craft is not setting backfires.

This second embodiment has been described with reference to the A-10 aircraft for illustrative purposes. It is apparent to those skilled in the art of fighting fires from the air that different craft may be used without departing from the spirit and scope of this invention or the associated methods as claimed here. These laser module systems may be attached to other craft to realize many of the same benefits.

### Operational Concept

The purpose of showing the photos in FIG. 4C is to not only indicate the space available when the Gatling gun is removed, but also the belly doors which provide access for laser system module installation, servicing, and replacement with a water/chemical tank or other module should it be desired to multi-task the aircraft beyond its laser backfiring service. In this water/retardant mode configuration the craft could for example, patrol day and night using its infrared sensitive camera capability to detect the infrared radiation emitted by even small fires as they start and then drop the retardant immediately. After alerting the fire control group of the fire's location, the craft could then return quickly to base either for more retardant or, if desired, to make a quick exchange to convert to the laser system module which would allow it to fly out and begin backfire protection. As previously stated, early backfire setting may drastically reduce the ultimate size of the conflagration and its loss of life and property and cost to extinguish.

This laser system module-assisted fixed wing firefighter will operate much as the helicopter. Note that its telescope has a 360 degree (2π radian) azimuthal angle coverage. Although it needs a runway unlike the helicopter, its cruise speed of 360 mph would allow it to quickly get to the region where the backfire is to be set. The laser system module aircraft will fight fires as follows. It will fly to a known fire's coordinates or locate the fire independently using its surveillance capabilities. Of course these capabilities will allow it to identify and avoid flight hazards and to report such information to the fire controlling agency. Approval to begin setting backfires may be given along with the desired paths or a more free-lance approval given. In either case the co-pilot fire manager aboard will enter the instructions into the laser beam pointing and tracking control system. Joy Stick operation or automatic operation will follow. This backfire operation will continue until the desired path is completed. If the craft needs refueling it will return to refueling base and then quickly return to complete the backfire task. Finally, as stated above, at that point the Fire Control Agency may order the craft to return to base to exchange its laser system module for a water/chemical tank to allow it to perform conventional retardant-drop firefighting. Alternatively, the Fire Controller may order the craft to stay aloft in order to use its enhanced surveillance capabilities to look for new flare-ups or to identify flight hazards such as transmission lines, other aircraft, etc.

### FIGS. 5A to 5B

### Second Alternative Embodiment

The prior embodiments related to piloted aircraft. But the emergence of UAVs, Unmanned Aerial Vehicles, or so-called Drones, offers interesting possible use for laser system module equipped UAVs. (More precisely, the International Civil Aviation Organization refers to these craft as Remotely Piloted Aircraft (RPA), i.e. aircraft without a human pilot aboard.) Its flight is controlled either by on board computers with pre-scripted flight plans or by the remote control of a pilot on the ground or in another vehicle. (Ref. 16) discusses UAV many uses, both military and civilian. Among these is remote fire detection: “Another application of UAVs is the prevention and early detection of forest fires. The possibility of constant flight, both day and night, makes the methods used until now (helicopters, watchtowers, etc.) become obsolete. [They may have] cameras and sensors that provide real-time emergency services, including information about the location [coordinates] of the outbreak of fire as well as many factors (wind speed, temperature, humidity, etc.) that are helpful for fire crews to conduct fire suppression.”

While present day laser system modules for backfire use may appear to be too heavy, voluminous, and inefficient to be accommodated in present day unpiloted aircraft, developments in both UAVs and in laser systems and our discoveries reported here should soon change this. Examples of recent developments by a Lockheed Martin-Kaman Aircraft team, FIG. 5A to FIG. 5D, indicate this. The pilot-less LM K-MAX (FIG. 5A) has just completed a demonstration program in Afghanistan. Over the last few months, this new unmanned military version of K-MAX 130 has been flying in Afghanistan, primarily to ferry meals ready to eat (MREs) and other supplies between bases in order to keep manned ground vehicles from making the hazardous trips on the IED-infested roads. As seen in FIG. 5C, the craft is remotely piloted by a marine 138 using his “Joy Stick” 134 which provides a signal through the antennas 132. Since last December 2013 a LM K-MAX has flown five flights per day, delivering over 600,000 pounds of cargo to troops in the field, flying over hazardous enemies and terrain, with no failures and no unscheduled down time.

This remarkable helicopter is based upon one designed by the chief engineer of those used by the German army in WW II. As seen in FIG. 5A it uses two separate blade systems 126 which counter-rotate to avoid the gyroscopic instability of a single-bladed craft which usually must use a tail rotor to counter it. Of course not only is the copter very stable but two blades gives it better lift capability even though it is a small craft.

Despite its small size, 15.8 m (51 ft) length, 4.14 m (13.6 ft) height, 14.7 m (48.25 ft) rotor diameter, its payload capacity is 2,727 kg (6,000 lbs). While this might appear to be too small to support a “conventional” 30-60 kW output power laser that we have discussed in previous embodiments, our further insight, as follows, will prove otherwise.

Foremost, we have no human aboard, and the safety risk tolerance can be markedly higher. As is well known for manned flight design, this dramatically lowers the weights (and costs) of safety features that had to be built into those aircraft we previously discussed. The same is true of the laser system module designs. But equally important, this allowable risk level also allows the remote UAV operator to fly the UAV much closer to the treetops or ground where the backfires are needed. Since the laser power received on target decreases with the square of the range between laser and target, reducing the range from say a “safe” 1 km to 0.1 km would require 10²=100 times less laser power to have the same fire-starting effect! In addition, if therefore instead of a 30 kW laser only a 0.3 kW one were required, smaller scale optics and less sophisticated beam control, would result! In brief, the laser system module volume, electric power, waste heat cooling and weight could dramatically decrease when it is used for backfire setting when mounted in a UAV like the LM K-MAX. Even the lower load capacity of 2,727 kg (6,000 lbs) would then easily suffice.

Another simplification is also possible. The K-MAX nominally carries its load 140 on a cable, as seen in FIG. 5D. If the cable also carried electric power from the aircraft to a laser package at the cable's lower terminus, then the target range might be made even smaller, say 0.01 km=10 m, and a very small 100-W-class laser output power might suffice for backfire ignition. But what must we assume for the design of this laser module package? All of the subsystem elements that we have required in the prior embodiments must be present. Note that the electric power could be provided by battery in the module or alternatively by an electric cable that is part of the support cabling. However the much lower laser powers required would allow smaller optics since their diameters scale downward with the square of the laser power handled. One issue of concern might be any sway of the module if it were held by cable rather attaching it to the underbelly of the craft. But there are remedies for this. First, the K-MAX cable-held payloads are much more stable than those suspended from other helicopter designs which suffer from the gyroscopic effect. Secondly, Kaman claims that the counter-rotating props provide much lower “down-wash” than conventional helicopters. Finally, it should be noted that the military has developed gyroscopically controlled laser beam pointing systems to keep the beam on its intended target even if it is reflected off a mirror held on such a cable by a helicopter.

Turning now to the last UAV photograph shown as FIG. 5E, the Lockheed Martin Vector Hawk is a just released Mini-UAV only a meter or so in width and length. This device has been constructed to allow its wing and tail sections to be folded under and above its fuselage, respectively. Then it may be launched like a mortar out of a tube to the desired flight altitude where it unfolds and begins cruising. This ingenious protocol is used to conserve the onboard battery's stored energy, which it would otherwise expend in gaining altitude. Thus payload capability and flight time enhancements result.

But in its present few kg payload capability limit, only very small designator lasers appear as possible laser payload. However even these could play an important role in firefighting by providing close-in directing of the illuminated aim points to be followed by a more powerful and distant laser system. Of course such low power laser target designation is presently used to guide missiles and even bullets on the battlefield.

Another important firefighting role that such a UAV could play is to provide infrared and optical surveillance. Without the risk of life, such a craft could be allowed to fly into harm's way, through smoke and darkness to obtain close-up infrared images. These could identify risks, or their absence, for follow-on manned aircraft. Of course general surveillance for fire flare-ups, need for restarting some backfires that have died, etc. would all be important information for the Fire Control Agency. Vector Hawk data link uses a high-bandwidth, software-defined radio. This would enable the transmission of these images and their GPS coordinates.

### Operational Concept

UAVs have unique capabilities to provide to firefighting. Not requiring pilots to prepare and come aboard, they are always ready to immediately take off for duty. This is an important issue to minimize a fire before it begins to spread. Once aloft they can immediately use their IR thermal cameras, day or night or veiled in smog or smoke, their images of infrared emitting hot spots can be quickly sent to Fire Control Headquarters. Then, either under programed GPS computer control, or being flown by a remote pilot, like FIG. 5C, at the Control Base on in another plane, to carry out the fight. With the ability to fly much closer to the target than a manned craft, their smaller, lower power laser system modules can be engaged to setting the optimum backfires. And the laser backfire ignition fire rate, being so much more rapid and effective than state of art methods, will be able to contain the fire to a smaller region, saving lives and property. When adequate backfires have been set, the UAV may turn to other of its multiple tasks. For surveillance, it may or may not even remove its laser system module package. On the other hand, for chemical retardant release, as seen in FIG. 5B, it would release its laser module at a base and attach a chemical belly tank as shown in FIG. 5B or use a cable supported water bucket tank, supported as seen in FIG. 5D. This operation may be reversed should more backfire duty is again required.

Finally, the operational use of a mini-UV like the LM Vector Hawk, FIG. 5E, is to provide the Fire Control Manager and the firefighting foot troops IR and white light images of the territory from high and very low vantage points. Needing to know in the dark which way to advance for best firefighting, or which way to move to escape an advancing fire, the foot soldier can tube launch the UAV and quickly decide on the course of action for his troops. Of course this surveillance can also continue as the crew sleeps, automatically awakening them by an alarm when a fire is observed. Finally, this UAV can, with low cost and no risk of life, be launched to explore regions that are covered with smoke or darkness in order to identify obstacles that manned craft or foot fire fighters might encounter.

Although the description above contains much specificity, these should not be construed as limiting the scope of the embodiments but as merely providing illustrations of some of several embodiments. For example, the laser system module can have many shapes and various subassemblies which may be provided by many vendors, etc. Thus the scope of the embodiments should be determined by the appended claims and their legal equivalents, rather than the examples given.

1.

11. A helicopter, fixed wing, or lighter-than-air manned or remotely piloted aircraft comprising
a. an infrared thermal vision enhancing system that allows the aircraft's crew to see fires, flight hazards and firefighter hazards despite darkness and smoke
b. a laser system module to provide a laser beam to set fires and backfires
c. a plurality of said laser system module's supporting subsystems incorporated into said aircraft
d. a control means for computer-assisted crew operation of said subsystems in order to generate and focus said laser beam to hit and ignite designated target foliage or treetops to produce a desired burn or a backfire line beyond a main fire to remove fuel from said main fire to negate its progress beyond the said backfire line
e. A GPS and electronic communications subsystem to provide location information to appropriate control centers of fire, border crossings, and other activities

12. The aircraft of claim 1 wherein said attachments allow installation of water and chemical equipment that may be used for firefighting, controlled burns, agriculture fertilizing and pest control, power line, windmill, building and other cleaning

13. The aircraft of claim 1 wherein said laser system module has a plurality of subsystem assemblies comprising at minimum a windowed turret assembly with beam director, a telescope, a beam transfer assembly, a beam control assembly, a storage volume for the turret, a high energy laser, a power supply and control, a waste heat and temperature control, a real-time fire control, and a tracking and imaging assembly enabling visual control
